(19) United States
(12) Patent Application Publication
(10) Pub. No.: US 2026/0338202 A1
(43) Pub. Date: Oct. 29, 2026

(54) ELECTROHYDRAULIC ACTUATOR

(71) Applicant: BUCHER HYDRAULICS AG, Neuheim (CH)

(72) Inventors: Eneko GOENECHEA, Waedenswil (CH); Dierk PEITSMEYER, Lohr am Main (DE); Christian Wolfgang SCHLEIHS, Zuerich (CH)

(21) Appl. No.: 19/106,967

(22) PCT Filed: Aug. 2, 2023
(86) PCT No.: PCT/EP2023/071446

§ 371 Date: Feb. 26, 2025

(30) Foreign Application Priority Data
Aug. 31, 2022 (DE) 10 2022 121 962.3

(51) Int. Cl. F15B 11/00; F15B 13/02; F15B 20/00; F15B 21/14

(52) U.S. Cl. CPC F15B 11/003; F15B 13/027; F15B 20/004; F15B 20/005; F15B 21/14; F15B 2211/20515; F15B 2211/20561; F15B 2211/30515; F15B 2211/8636; F15B 2211/8757

(57) ABSTRACT

The invention relates to an electrohydraulic actuator (1), comprising at least one bidirectionally operable hydraulic pump (2) for conveying hydraulic fluid, said hydraulic pump having two connection points (6a, 6b) which are designed to alternately provide and/or withdraw hydraulic fluid, and having a hydraulic actuator component (3) which has two hydraulic fluid chambers (4a, 4b) into which hydraulic fluid can be fed in order to actuate the hydraulic actuator component (3), wherein: filling one of the hydraulic fluid chambers (4a, 4b) with hydraulic fluid simultaneously causes hydraulic fluid to be displaced from the other hydraulic fluid chamber (4b, 4a); a first connection point (6a) of the hydraulic pump (2) is connected to a first hydraulic fluid chamber (4a) of the hydraulic actuator component (3) by a first line (7a) and a second connection point (6b) of the electric hydraulic pump is connected to a second hydraulic fluid chamber (4b) of the hydraulic actuator component (3) by a second line (7b); a first releasable hydraulic closure element (8a) is disposed between the first hydraulic fluid chamber (4a) and the first line (7a) and a second releasable hydraulic closure element (8b) is disposed between the second hydraulic fluid chamber (4b) and the second line (7b); the releasable hydraulic closure elements (8a, 8b) prevent undesired flow of hydraulic fluid out of the hydraulic fluid chambers (4a, 4b); and the releasable hydraulic closure elements (8a, 8b) are designed such that, for a release, both an electrical release signal and a hydraulic release signal must be present at the releasable hydraulic closure 4 elements (8a, 8b).

The invention relates to an electrohydraulic actuator, in particular a linear actuator, which can cause a linear actuator movement. The electrohydraulic actuator comprises a hydraulic actuator component and an electrically driven hydraulic pump which provides hydraulic fluid to drive the hydraulic actuator component.

In particular, the electrohydraulic actuator described here can be operated in up to four quadrants, i.e., the actuator is four-quadrant-capable. Four-quadrant capability means that the electrohydraulic actuator can be driven with electrical energy in two directions of movement in order to generate an actuator movement and, in addition, recuperation is also possible in the two directions of movement, in which mechanical energy can be extracted from the actuator movement and converted into electrical energy.

Such electrohydraulic actuators are particularly suitable for electrifying and increasing the energy efficiency of mobile machinery with hydraulic components. Due to the four-quadrant capability of such linear actuators, considerable amounts of energy can be recuperated into electrical energy during the operation of mobile machinery. This would be possible, for example, in a situation in which an excavator shovel driven by the electrohydraulic actuator is lowered. The position energy of the excavator shovel can then be dissipated into a hydraulic fluid flow using the hydraulic actuator component. Energy can be extracted from this hydraulic fluid flow with the electric hydraulic pump in a generator mode and converted into electrical energy.

Hydraulic actuators are regularly safety-relevant components. In the case of hydraulic actuators in mobile machinery, for example, it must be ensured that no unwanted or uncontrolled movements of components of the mobile machinery occur in the event of a fault. For example, a crane arm or excavator bucket must not drop in an uncontrolled manner in the event of a fault. Resilience to such scenarios is dealt with in the field of “functional safety”.

The object of the present invention is to describe an electrohydraulic actuator which, with regard to operational safety in the event of possible faults occurring, has particularly good behavior and at the same time has an advantageous design. This object is achieved by the invention according to the features of the independent claim. Further advantageous embodiments are given in the independently formulated claims as well as in the description and in particular also in the description of the figures. It should be noted that the person skilled in the art combines the individual features with each other in a technologically meaningful way and thus arrives at further embodiments of the invention.

An electrohydraulic actuator is to be described here, having at least one bidirectionally operable electric hydraulic pump for conveying hydraulic fluid, said pump having two connection points, which is designed to alternately provide and/or remove hydraulic fluid, and having a hydraulic actuator component with two hydraulic fluid chambers into which hydraulic fluid can be fed in order to actuate the hydraulic actuator component, wherein filling one of the hydraulic fluid chambers with hydraulic fluid simultaneously causes hydraulic fluid to be displaced from the other hydraulic fluid chamber, wherein a first connection point of the hydraulic pump is connected by a first line to a first hydraulic fluid chamber of the hydraulic actuator component and a second connection point of the hydraulic pump is connected by a second line to a second hydraulic fluid chamber of the hydraulic actuator component, wherein a first releasable hydraulic closing element is arranged between the first hydraulic fluid chamber and the first line and a second releasable hydraulic closing element is arranged between the second hydraulic fluid chamber and the second line, wherein the releasable hydraulic closing elements prevent an undesired flow of hydraulic fluid out of the hydraulic fluid chambers, wherein the releasable hydraulic closing elements are arranged in such a way that, for a release, both an electric release signal and a hydraulic release signal must be applied to the releasable hydraulic closing elements.

Options for the structure and design of the electrohydraulic actuator and, in particular, the structure of the hydraulic actuator component and electric hydraulic pump are described in detail below. In principle, it is preferred that both the hydraulic pump and the actuator component each have two connection points for hydraulic fluid (each acting as an inlet or outlet), which are each connected to each other via a line, so that a delivery circuit for hydraulic fluid is formed. Otherwise, hydraulic pumps and actuator components of various designs can be used. It should also be noted here that the hydraulic actuator component can also be a parallel connection of several hydraulic (individual) actuator components. For example, the hydraulic actuator component can be a pair of hydraulic cylinders acting side by side (in parallel), which together with an electric hydraulic pump form an electrohydraulic actuator and which are referred to as tandem cylinders, for example. Lines from the hydraulic pump to the hydraulic (individual) actuator components are then preferably branched, wherein the branches may be understood as part of the actuator component. In principle, it is just as possible to divide the actuator component into (individual) actuator components as it is to divide the hydraulic pump into (individual) hydraulic pumps.

In order to achieve particularly good protection in terms of functional safety through the releasable hydraulic closing elements, it is advantageous if releasable hydraulic closing elements are arranged directly at the transitions of the lines to the hydraulic fluid chambers of the actuator components. Several releasable hydraulic closing elements, which are arranged at corresponding connection points of (individual) actuator components of a hydraulic (overall) actuator component connected in parallel to each other, can then also be understood as a (common) releasable hydraulic closing element.

The releasable hydraulic closing elements are therefore arranged between the lines that connect the actuator component to the hydraulic pump and the hydraulic fluid chambers. The releasable hydraulic closing elements are designed to hydraulically separate the hydraulic fluid chambers of the actuator component from the lines. An escape of hydraulic fluid from the hydraulic fluid chambers can be reliably prevented with the releasable hydraulic closing elements if the releasable hydraulic closing elements are locked or released. The releasable hydraulic closing elements are designed to be locked in the idle state (without release signals acting on them).

The term “released” means that the releasable hydraulic closing elements are open. In this situation, the releasable hydraulic closing elements preferably have no or very little effect on the flow of hydraulic fluid in the lines or into or out of the hydraulic fluid chambers. To release the releasable hydraulic closing elements, both release signals (the electric release signal and the hydraulic release signal) must be applied to the releasable hydraulic closing elements. In normal operation, the hydraulic closing elements are released and both release signals (the electric release signal and the hydraulic release signal) are therefore applied to the releasable hydraulic closing elements. At least one of the release signals can also be applied indirectly, for example by the releasable hydraulic closing elements and the electrohydraulic actuator being set up in such a way that a hydraulic release signal is only forwarded to the releasable hydraulic closing element if an electric release signal is also present.

An arrangement of the releasable hydraulic closing elements between the lines connecting the actuator component with the hydraulic pump and the hydraulic fluid chambers fulfills all or part of the following characteristics:
Advantageously, no further branches to other hydraulic components such as expansion tanks, intermediate circuits etc. are provided between the releasable hydraulic closing elements and the hydraulic fluid chambers. However, compensating lines can be provided to other parallel cylinders, which together form an actuator component. Such compensation lines are common, for example, between the two individual cylinders of a tandem cylinder, as is often used, for example, in the lowest stage of an excavator arm.
Hydraulic fluid-carrying portions on the side of the releasable hydraulic closing elements facing the hydraulic fluid chambers preferably have a very high leakage resistance. Preferably, such hydraulic fluid-carrying portions are not made of flexible materials such as hoses or the like and may be completely metallic.
The hydraulic closing elements are advantageously set up to close regardless of other boundary conditions if the electric release signal required for release and the hydraulic release signal required for release are not present. Such a further boundary condition is, for example, a maximum permissible pressure in the actuator component, which, if exceeded, could cause the actuator component to burst. Another such boundary condition is, for example, a maximum permissible braking acceleration of the actuator component which, due to mass inertia, could trigger forces and/or torques on a mobile machine that exceed the permissible limit values. Many other such boundary conditions regularly exist. Such boundary conditions are not taken into account when closing the hydraulic closing elements as a result of the loss of one of the release signals. The locking takes place to secure the electrohydraulic actuator regardless of the effects that may occur if such boundary conditions are exceeded or violated. Preferably, however, the hydraulic closing elements have additional functions that are integrated in the valve and which ensure that the actual exceeding of such boundary conditions does not occur. Such additional functions are, in particular, bypass functions which act above certain limit pressures and which are explained in more detail below.

It is particularly advantageous if the releasable hydraulic closing elements are releasable non-return valves.

Preferably, the releasable hydraulic closing elements act as non-return valves, particularly in a working pressure range, when the aforementioned release signals are not present. This means that hydraulic fluid can flow into the hydraulic fluid chambers in the working pressure range, but hydraulic fluid cannot flow out. The “working pressure range” here refers to a pressure range of the hydraulic fluid in the lines and hydraulic fluid chambers that occurs regularly during operation of the electrohydraulic actuator, wherein pressure peaks that occur, for example, due to sudden valve closures and/or acceleration of hydraulic fluid volumes in the line are preferably not by the working pressure range. Such pressure peaks are preferably outside the working pressure range. Preferably, the releasable hydraulic closing elements have additional functions in the form of bypass channels and/or bypass functions, which open at pressures above the working pressure range and then, despite acting as a non-return valve in the working pressure range, allow a limited amount of hydraulic fluid through in order to buffer such pressure peaks and to prevent the working pressure range from being permanently overwritten. Such functions are primarily used for component protection, for example to prevent a hydraulic actuator component from bursting due to pressure peaks that occur in the hydraulic fluid chambers as a result of sudden deceleration due to the closing of the releasable hydraulic closing elements.

Additional functions or bypass functions can, if necessary, be realized by a pressure relief valve acting parallel to the hydraulic closing element, which opens at a pressure above a working pressure limit value and thus allows a certain braking distance of the actuator component. At pressures within the working pressure range or below the working pressure limit value, such a pressure relief valve is preferably inoperative. If the closing element closes as quickly as possible and the working pressure limit value is exceeded as a result, the parallel-acting pressure relief valve opens, for example, in such a way (as far and/or as long) as to achieve a compromise between “braking distance” and load on the actuator component.

Another alternative to the pressure relief valve in the bypass is that the releasable hydraulic closing elements can be set up for damped closing. This can also reduce the pressure peaks. So if one of the release signals is omitted, the releasable hydraulic closing elements preferably close with a certain time delay, which may also depend on the pressures applied/occurring.

In principle, the hydraulic closing elements are designed so that in normal operation (in the open state when release signals are applied) they cause the lowest possible flow resistance and pressure drop when hydraulic fluid flows into and out of the hydraulic fluid chamber. This is advantageous for the best possible energy efficiency of the electrohydraulic actuator.

It is also advantageous if the hydraulic actuator component has a displaceable element via which the hydraulic fluid chambers communicate with one another and wherein the hydraulic actuator component with the lines and the hydraulic pump at least partially form a delivery circuit, so that hydraulic fluid emerging from one hydraulic fluid chamber can flow directly into the other hydraulic fluid chamber via the lines and the hydraulic pump.

The concept of a flow “directly” into a chamber in this case means in particular that hydraulic fluid flowing out of a hydraulic fluid chamber does not first flow into a reservoir for hydraulic fluid to which several hydraulic actuator components are connected, but via the hydraulic pump directly into the other hydraulic fluid chamber of the same hydraulic actuator component.

When using the electrohydraulic actuator, there is therefore preferably a circular delivery of hydraulic fluid in the delivery circuit, in which the displaceable element in the hydraulic actuator component participates. The term “communication” of the hydraulic fluid chambers means in particular that a change in volume of one hydraulic fluid chamber always inevitably causes a change in volume of the other hydraulic fluid chamber. On the one hand, the displaceable element is moved by the hydraulic fluid. On the other hand, the displaceable element also transmits the movement of the hydraulic fluid in one of the hydraulic fluid chambers to the other hydraulic fluid chamber and vice versa. By driving the hydraulic pump with the different delivery directions, the displaceable element can be moved by the hydraulic fluid. Actuator movements of the actuator component are movements of the displaceable element and components connected to it. Preferably, the conveying circuit is not completely self-contained, but is connected to an intermediate hydraulic circuit via other hydraulic components. However, this intermediate circuit does not itself participate directly in the circular delivery of hydraulic fluid in the delivery circuit, but is rather set up to ensure suitable operating conditions for circular delivery in the delivery circuit. Further explanations are provided below and in particular in the description of the figures.

Furthermore, it is advantageous if the hydraulic fluid chambers of the hydraulic actuator component have hydraulic cross-sections that differ from one another, so that a delta volume occurs as a change in the total volume of the hydraulic fluid chambers when the displaceable element is displaced, wherein the hydraulic pump has a two-part pump chamber and a first partial pump chamber connects the lines to form the delivery circuit and wherein a second partial pump chamber is connected to the line to the hydraulic fluid chamber with the larger hydraulic cross-section and to a hydraulic fluid reservoir, with which the delta volume can be compensated.

Hydraulic actuator components in which the two corresponding hydraulic fluid chambers have different hydraulic cross-sections are widespread. They are regularly referred to as differential components (e.g., differential cylinders). The different volumes result, for example, from the fact that one of the two hydraulic fluid chambers accommodates a feed rod that transmits a movement of the displaceable element to components of a mobile machine (e.g., to the arm of an excavator).

With hydraulic actuator components of this type, the principle of circular delivery and the delivery circuit is only possible for the part of the hydraulic fluid that can be absorbed in the hydraulic fluid chamber with the smaller hydraulic cross-section. Any additional quantity of fluid escaping from the hydraulic fluid chamber with the larger hydraulic cross-section is referred to here as the “delta volume”. The delta volume must not only be discharged when the displaceable element is moved towards the hydraulic fluid chamber with the larger hydraulic cross-section and its volume is reduced. The delta volume must also be supplied when the displaceable element is moved towards the hydraulic fluid chamber with the smaller hydraulic cross-section and the volume of the hydraulic fluid chamber with the larger hydraulic cross-section increases.

To realize this, a hydraulic pump with a two-part pump chamber is proposed here. The first partial pump chamber forms part of the delivery circuit. The first partial pump chamber is dimensioned so that the volume that can flow from one hydraulic fluid chamber to the other hydraulic fluid chamber is conveyed with it. The second partial pump chamber is used to pump hydraulic fluid from a hydraulic fluid reservoir into the circuit or to drain it from the circuit into the hydraulic fluid reservoir. This serves to equalize the delta volume-i.e., to supply or discharge, depending on the direction in which the displaceable element is moved. Preferably, both partial pump chambers are connected to a common pump drive motor, possibly via a common shaft. Energy can be both supplied to and extracted from the hydraulic fluid flow via both partial pump chambers in order to be converted (recuperated) into electrical energy.

It is also advantageous if the first line and the second line are each connected to a store for hydraulic fluid, which is set up to compensate for function-related fluctuations in a minimum system pressure in the closed hydraulic system.

It is also advantageous if the store is connected to the first line and the second line via further hydraulic closing elements, wherein these further hydraulic closing elements prevent the transmission of an operating pressure generated by the hydraulic pump in one of the two lines to the store.

Such a store is preferably part of the hydraulic intermediate circuit described above. Preferably, this store is connected to the lines via further hydraulic closing elements, which are in particular non-return valves and via which hydraulic fluid can flow into the lines if a minimum pressure is no longer maintained there. However, the store is designed in such a way that no leakages in the lines can be compensated via the store, but only function-related fluctuations that can occur, for example, due to fluctuating ambient pressures, thermal expansion behavior of the hydraulic fluid and similar phenomena.

Preferably, the store is also connected to the delivery circuit in such a way that excessively high pressures can also be drained from the delivery circuit into the store. The store and the hydraulic intermediate circuit are preferably connected to a hydraulic fluid supply that provides the store and the intermediate circuit with the amount of hydraulic fluid required to support the pumping operation.

It is also advantageous if the releasable hydraulic closing elements have a hydraulic release signal input to which a hydraulic signal line is connected, via which the presence of a hydraulic system pressure of the electrohydraulic actuator is monitored as a hydraulic release signal.

The hydraulic signal line is a functional connection that is realized with hydraulic and/or hydraulic-mechanical components. The signal-conducting connection can be implemented using any technical means. The signal-conducting connection represents a connection to components in which or on which a hydraulic system is present during regular operation of the electrohydraulic actuator. The hydraulic system pressure is transmitted to the hydraulic release signal via the signal-conducting connection and acts there as a hydraulic release signal. If the hydraulic system pressure drops or falls below a threshold value, this is transmitted to the hydraulic release signal via the signal-conducting connection. There, the hydraulic release signal disappears and the releasable hydraulic closing elements close.

The hydraulic release signal input is preferably an active surface on the releasable hydraulic closing element, to which a minimum pressure must be applied for a release to take place. If necessary, the release signal input can also be set up so that a maximum pressure must not be exceeded. The hydraulic release signal would therefore be an applied pressure signal in a specified pressure range.

It is also advantageous if the hydraulic release signal input is connected to the store via the hydraulic signal line in order to monitor the hydraulic system pressure.

Preferably, there is a pressure transmission line from the store to the two releasable hydraulic closing elements. If necessary, the pressure transmission line can be made in several parts. If necessary, the pressure transmission line can also be interrupted by pressure transmission elements which, although they prevent hydraulic fluid from spilling over, transmit pressure changes to the release signal input. A connection between the store and the hydraulic release signal input is in particular also a purely functional connection that enables the pressure or pressure changes in the store to be transmitted to the hydraulic release signal input.

It has been found that using the pressure in the store of the intermediate circuit is a very efficient parameter that can be used to determine whether there is a fault in the hydraulic components of the electrohydraulic actuator that justifies or makes it necessary to close the releasable hydraulic closing elements. Operation-related pressure fluctuations in the delivery circuit are compensated for by the store. The hydraulic fluid supply preferably contributes to maintaining a pressure in the store as long as the store (only) compensates for operational fluctuations in the delivery circuit that are not the cause of a fault (leakage, etc.). If fluctuations can no longer be compensated by the store, it can be assumed that the fluctuations are due to a fault (leakage, etc.). In this case, it is desirable to block the hydraulic closing elements that can be released or to stop releasing them. Such behavior can be achieved by connecting the store to the hydraulic release signal input.

It is also advantageous if the releasable hydraulic closing elements have at least one electric release signal input, to which the electric signal line is connected, via which the presence of a function signal of the electric hydraulic pump and/or a function signal of a drive power supply and/or a control of the electric hydraulic pump is monitored as an electric release signal.

This electric signal line is preferably also a functional connection, which is preferably at least partially realized with electrical components.

The electric release signal is preferably used to monitor whether there is a fault in the electrical components of the electrohydraulic actuator, for example the absence of the supply voltage of a control unit, an interruption in the drive power supply, etc. In embodiments, the presence or absence of other voltages and/or signals (in particular several voltages) can also be monitored and monitored at the electric release signal input.

In particular, the electric release signal is used to monitor whether an overvoltage and/or undervoltage occurs in the drive power supply of the control unit and/or the power electronics in the drive power supply (for example on an inverter to supply the electric hydraulic pump with electrical power).

Preferably, there is a control unit for self-monitoring an inverter in the drive power supply. Preferably, such a control unit emits a so-called “enable signal”, which can be used as a release signal, which is connected to the electric release signal input via a line.

Such a control unit in the drive power supply monitors internal signals and states and detects (more or less reliably) a “loss of control”.

If necessary, setpoint/actual value deviations provided by external (safety) electronics that monitor the movement of the actuator component, for example, can also be taken into account as an electric release signal. An external (safety) electronic system is, in particular, an electronic system which is superordinate to the electrohydraulic actuator component described here and which is preferably set up to monitor the effects of the electrohydraulic actuator component in its intended function. If the electrohydraulic actuator component is used, for example, to actuate an excavator arm, then external (safety) electronics can be connected, for example, to sensors that monitor the movement of the excavator arm and determine whether these movements are moved as expected and desired as a result of control signals to the electrohydraulic actuator.

For example, travel and speed signals can be determined and monitored. Such signals can, for example, be transmitted from the external (safety) electronics to the control unit of the electric hydraulic pump, where they can be collected and evaluated if necessary. As long as target values or target value ranges for such signals are maintained by actual values of such signals, an electric release signal is preferably output, which is applied to the electric release signal input. As soon as such target values and/or target value ranges are exceeded or left by actual values, an electric release signal is preferably no longer provided. The releasable hydraulic closing elements are then blocked.

External (safety) electronics can preferably also be used to evaluate measured values relating to the operation of the electrohydraulic actuator itself. For example, pressure sensors, force sensors, acceleration sensors, etc. can be provided on components of the electrohydraulic actuator in order to monitor its function. This allows very high safety standards to be maintained.

The electric hydraulic pump is preferably controlled by a controller. Preferably, the controller has at least one output stage that drives the electrical drive power for the hydraulic pump in response to control signals from higher-level control components of a mobile work-performing machine, so that the hydraulic actuator component performs the desired actuator movements. A supply voltage can, for example, be an input voltage of the output stage, which is used by the control system in response to the control signals to transmit the electrical drive power to the hydraulic pump. Electrical parameters that can be determined in the output stage and that are essential for the operation of the electrohydraulic actuator can also be used as an electric release signal.

In preferred embodiments, the electric release signal is a digital signal which is formed from various individual release signals, wherein the individual release signals are linked to one another in a suitable manner-for example with AND links, so that several individual release signals must be present simultaneously in order to form the electric release signal, or with OR links, so that several individual release signals must be present alternatively to one another in order to form the electric release signal. If necessary, a more complex network may exist, which forms the electric release signal from a large number of individual signals.

It is particularly advantageous if the hydraulic pump is set up in such a way that it can also act as a generator to convert the mechanical energy of a hydraulic fluid flow from one connection point to the other connection point into electrical energy.

The electrohydraulic actuator is particularly preferably set up to transmit mechanical energy to the hydraulic actuator component through the lines and via the hydraulic fluid to the electric hydraulic pump and to recuperate it into electrical energy with the hydraulic pump.

The possibility of operating the hydraulic pump in generator mode has already been explained above in conjunction with the four-quadrant capability of the electrohydraulic actuator. The electrohydraulic actuator described here is a four-quadrant actuator that is capable of recuperation and at the same time has a high level of functional safety (due to the releasable hydraulic closing elements and their linking with both electric release signals and hydraulic release signals).

It is also advantageous if the hydraulic actuator component is a linear actuator.

The design described is particularly suitable for providing actuators that can be used to generate very large linear forces.

The electrohydraulic actuator described here is preferably set up to generate a mechanical output of more than 10 kW [kilowatts].

Also to be described here is a mobile work-performing machine comprising at least one electrohydraulic actuator as described.

The mobile work-performing machine can be an excavator or similar machine, for example. However, the electrohydraulic actuators described here can also be used in other applications.

The invention and the technical context of the invention are explained in more detail below with reference to the figures. The figures show preferred exemplary embodiments to which the invention is not limited. In particular, it should be noted that the figures and in particular the scale ratios shown in the figures are only schematic. The figures show:

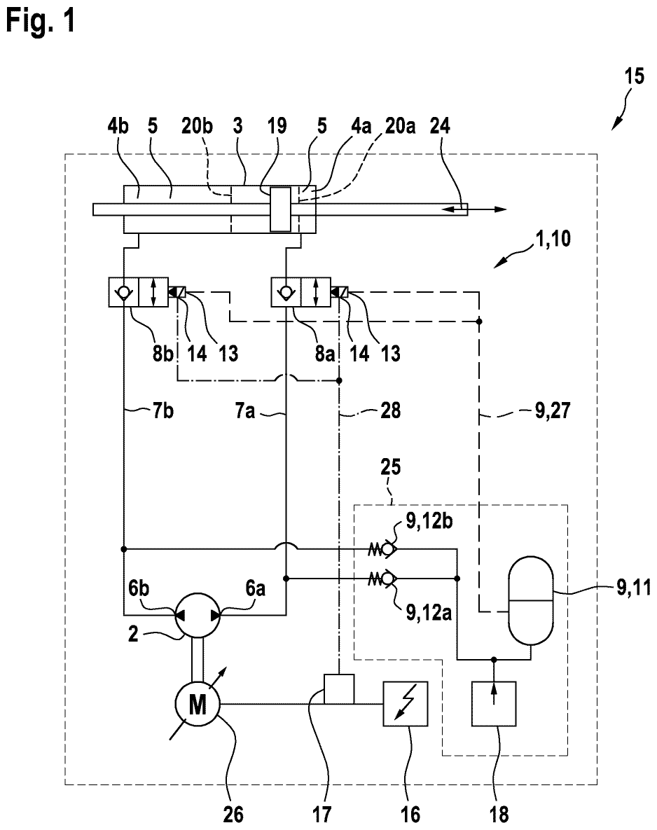

FIG. 1: a first variant of a described electrohydraulic actuator, and

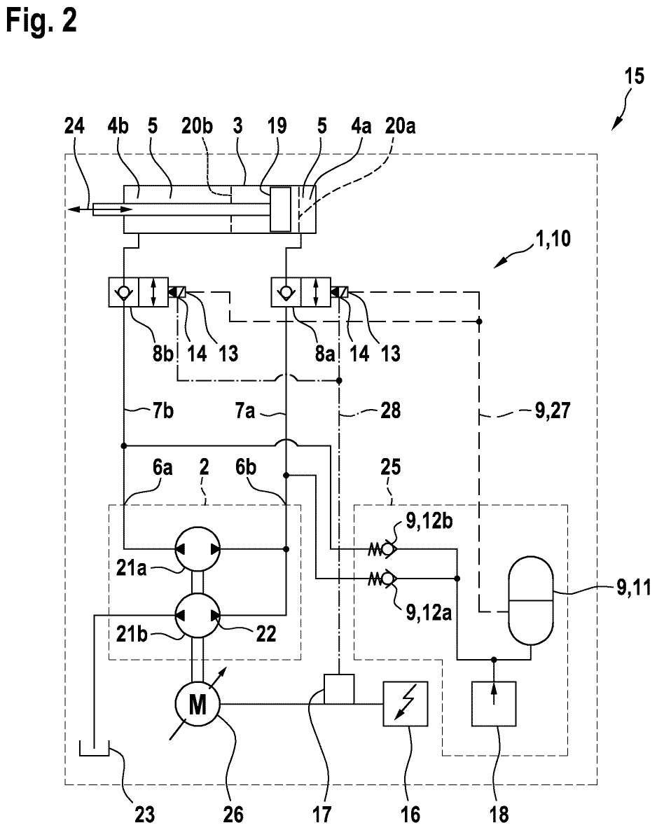

FIG. 2: a second variant of a described electrohydraulic actuator.

FIG. 1 shows a variant of a described electrohydraulic actuator 1, in which a hydraulic actuator component 3 has hydraulic fluid chambers 4a, 4b with the same hydraulic cross-sections 20a, 20b. The total actuator volume 5 is here independent of the position of the displaceable element between the two hydraulic fluid chambers 4a, 4b. FIG. 2 shows a variant of a described electrohydraulic actuator 1, in which a hydraulic actuator component 3 has hydraulic fluid chambers 4a, 4b with different hydraulic cross-sections 20, 20b. The total actuator volume 5 here depends on the position of the displaceable element between the two hydraulic fluid chambers 4a, 4b and is variable. Such hydraulic actuator components 3 are also called, for example, differential hydraulic actuator components 3 or (in the case of hydraulic cylinders as hydraulic actuator components 3) also “differential cylinders”. Such differential hydraulic actuator components 3 are widely used. The invention described here does not differ fundamentally as to whether the hydraulic actuator component 3 is a differential hydraulic actuator component 3 or not. However, some differences are to be noted, so that in FIGS. 1 and 2 the electrohydraulic actuator 1 according to the invention is to be described once with a differential hydraulic actuator component 3 and once with a non-differential hydraulic actuator component 3. However, identical features in both variants are described together here.

The electrohydraulic actuator 1 has the hydraulic actuator component 3 and the electric hydraulic pump 2, which can be driven by an electric pump drive motor 26. The hydraulic actuator component 3 typically has two hydraulic fluid chambers 4a, 4b, between which there is a displaceable element 19, which can be moved by filling one hydraulic fluid chamber 4a, 4b and simultaneously emptying the other hydraulic fluid chamber 4b, 4a in order to generate an actuator movement 24. In this way, large forces can be generated in the hydraulic actuator component 3, which can be used, for example, to drive an excavator arm or a crane arm.

In the electrohydraulic actuator 1 described here, both hydraulic fluid chambers 4a, 4b are each connected to connection points 6a, 6b of the electric hydraulic pump 2 via a line 7a, 7b. The hydraulic actuator component 3 or the two hydraulic fluid chambers 4a, 4b of the hydraulic actuator component 3, the lines 7a, 7b and the electric hydraulic pump 2 together form a delivery circuit 10. The electric hydraulic pump 2 can be used to build up pressure at one of its connection points 6a, 6b and to provide hydraulic fluid under pressure at this connection point 6a, 6b, so that the hydraulic fluid flows via the respective line 7a, 7b into the respective hydraulic fluid chamber 4a, 4b of the actuator component. In the process, the hydraulic pump 2 delivers hydraulic fluid that is provided to it at the respective other connection point 6b, 6a and which is therefore removed from the respective other hydraulic fluid chamber 4b, 4a via the respective other line 7a, 7b. The hydraulic pump 2 can optionally be operated in both delivery directions, i.e., provide hydraulic fluid under pressure at the first connection point 6a or at the second connection point 6b and thus generate actuator movements 24 in different directions with the hydraulic actuator component 3. In this way, the electrohydraulic actuator 1 can be used to convert electrical energy into mechanical energy, which is provided at the hydraulic actuator component 3. The electrical energy is first converted into hydraulic energy by the electric hydraulic pump 2 and then into mechanical energy by the hydraulic actuator component 3 with the actuator movement 24. The actuator movement 24 can be used, for example, to move an excavator shovel driven by the hydraulic actuator component 3. The electric hydraulic pump 2 operates here in a so-called delivery mode. The pump drive motor 26 is driven electrically here. This is preferably possible in both conveying directions.

With the aid of the electrohydraulic actuator 1, it is preferably also possible to convert mechanical energy of the actuator movement 24 into electrical energy. First, mechanical energy of the actuator movement 24 is converted or recuperated into hydraulic energy with the actuator component 3 and then into electrical energy with the electric hydraulic pump 2 or the electric pump drive motor 26. This can be used, for example, to convert the position energy of an excavator shovel driven by the hydraulic actuator component 3 into electrical energy. The electric hydraulic pump 2 is then operated in so-called generator mode. This is also preferably possible in both conveying directions.

An electric hydraulic pump 2 that can work in both directions in delivery mode and in generator mode is also referred to as being 4-quadrant capable. The delivery circuit 10 formed by the lines 7a, 7b, the hydraulic pump 2 and the hydraulic actuator component 3 or its hydraulic fluid chambers 4a, 4b can therefore be operated in both directions, in delivery mode or in generator mode.

The electrohydraulic actuator 1 or the delivery circuit and in particular the lines 7a, 7b are connected to a hydraulic intermediate circuit 25. The hydraulic intermediate circuit 25 has only an indirect function for the generation of mechanical energy at the hydraulic actuator component 3 from electrical energy and the recuperation of mechanical energy at the hydraulic actuator component 3 into electrical energy, namely to ensure suitable hydraulic conditions in the delivery circuit 10 so that the delivery operation and the generator operation are both possible with the highest possible efficiency of the conversion of electrical energy into mechanical energy and vice versa.

The intermediate circuit 25 comprises a number of other hydraulic components 9, the most important of which will be briefly explained here. The hydraulic intermediate circuit 25 is connected to the lines 7a, 7b with further hydraulic closing elements 12a, 12b. The additional closing elements 12a, 12b allow hydraulic fluid to flow into the delivery circuit 10 if the pressure in the delivery circuit 10 in one of the two lines 7a, 7b is too low. However, the hydraulic intermediate circuit 25 is set up in such a way that no hydraulic fluid losses above threshold values in the delivery circuit 10 are compensated, but only acceptable fluctuations during regular operation.

Preferably, the hydraulic intermediate circuit 25 has a store 11, which holds a reservoir of hydraulic fluid ready to receive hydraulic fluid from the delivery circuit 10 via the closing elements 12a, 12b and the pressure release and to release it to the delivery circuit 10, where it maintains the conditions suitable for operation. The intermediate circuit 25 and in particular the store 11 are themselves supplied with hydraulic fluid by a hydraulic fluid supply 18, for example.

At the connection between the hydraulic fluid chambers 4a, 4b and the lines 7a, 7b, there is a hydraulic closing element 8a, 8b that can be released, which is in particular a non-return valve. When this releasable hydraulic closing element 8a, 8b is closed, hydraulic fluid can no longer escape from the hydraulic fluid chambers 4a, 4b. In this way, the hydraulic actuator component 3 is locked. The releasable hydraulic closing elements 8a, 8b thus ensure that the hydraulic actuator component 3 or components driven by it (such as an excavator shovel) do not perform any undesired (uncontrolled) movements in the event of malfunctions of the hydraulic actuator component 3 or other parts of a mobile work-performing machine 15.

The releasable hydraulic closing elements 8a, 8b are set up so that they are closed unless two independent release signals are present, namely an electric release signal and a hydraulic release signal. The electric release signal and the hydraulic release signal are thus linked to each other at the releasable hydraulic closing elements 8a, 8b or preferably by the structure of the releasable hydraulic closing elements 8a, 8b in the manner of a logical AND operation. Preferably, the releasable hydraulic closing elements 8a, 8b have a hydraulic release signal input 13 for the hydraulic release signal and an electric release signal input 14 for the electric release signal.

The hydraulic release signal is present when the hydraulic components of the electrohydraulic actuator 1 are functioning properly. The hydraulic release signal is omitted, for example, if there is a leak in the first line 7a and/or the second line 7b. The hydraulic release signal is preferably derived at the previously described store 11 of the hydraulic intermediate circuit 25. If a pressure in the store 11 is above a predetermined threshold pressure, the hydraulic release signal is present. The pressure in the store 11 can be used to monitor the tightness of the entire system consisting of the delivery circuit 10 and the intermediate circuit 25. If the pressure in the store 11 is above a threshold pressure, it can be recognized that there is no leakage in the delivery circuit 10 and/or the intermediate circuit 25. Preferably, the store 11 is connected directly to hydraulic release signal inputs 13 of the releasable hydraulic closing elements 8a, 8b via a hydraulic signal line 27.

The electric release signal is present when the electrical components of the electrohydraulic actuator 1 and possibly also the higher-level components of the mobile work-performing machine 15 are functioning properly. The electric release signal can be obtained, for example, at an electric control unit 17 of the electric hydraulic pump 2, which controls a pump drive motor 26 of the electric hydraulic pump 2. Preferably, the electric control unit 17 is set up to generate the electric release signal from internal electric variables of the electric control unit 17, a drive power supply 16 and possibly from other variables that the electric control unit receives from external safety electronics. The electric release signal can preferably be formed from individual release signals that are connected to each other with suitable links (“AND” links or “OR” links) in order to form an electric release signal that represents complete functionality of the electrical components of the electrohydraulic actuator 1. If the electric release signal is applied to the releasable hydraulic closing elements 8a, 8b, it can be assumed that the electrical components of the electrohydraulic actuator 1 (in particular the pump drive motor 26, the control unit 17 and the drive power supply 16) are fully functional. Preferably, the electric release signal is forwarded directly to electric release signal inputs 14 of the releasable hydraulic closing elements 8a, 8b via an electric signal line 28. The control unit 17 is preferably supplied with electrical energy for supplying the electrohydraulic actuator 1 by a drive power supply 16, which provides a supply current or a supply voltage. Preferably, the control unit 17 and the drive power supply 16 are also capable of recuperation. This means that energy recuperated from the electrohydraulic actuator 1 can be fed back into the drive power supply 16.

The above explanations first describe the mode of operation of the electrohydraulic actuator 1 using the variant shown in FIG. 1. The electrohydraulic actuator 1 shown in FIG. 2 with a differential cylinder as actuator component 3 has further (in some cases slightly different) properties, which will be briefly discussed here. In the variant shown in FIG. 2, the electric hydraulic pump 2 preferably has a first partial pump chamber 21a and a second partial pump chamber 21b. The different hydraulic cross-sections 20a, 20b result in a delta volume 22, which is shown here at the inlet of the second partial pump chamber 21b, because it is conveyed through the second partial pump chamber 21b during operation of the electrohydraulic actuator 1. Preferably, both partial pump chambers 21a, 21b are driven by a common pump drive motor 26. The first partial pump chamber 21a essentially corresponds to the pump chamber (not shown separately) of the electric hydraulic pump 2 according to the embodiment according to FIG. 1. This partial pump chamber 21a is connected to the two lines 7a, 7b and forms the delivery circuit 10 with the lines 7a, 7b and the hydraulic fluid chambers 4a, 4b of the hydraulic actuator component 3.

The second partial pump chamber 21b is only connected to the first line 7a to the first hydraulic fluid chamber 4a, which has the larger first hydraulic cross-section 20a. The second partial pump chamber 21b is also connected to a hydraulic fluid reservoir 23, into which hydraulic fluid is drained or from which hydraulic fluid is taken up during operation of the electrohydraulic actuator 1, depending on the direction of delivery. The hydraulic fluid reservoir 23 may also be pressurized in order to store hydraulic energy in the hydraulic fluid. The recuperation of mechanical energy from the actuator movement 24 into electrical energy is also preferably possible.

### LIST OF REFERENCE SIGNS

1 electrohydraulic actuator
2 electric hydraulic pump
3 hydraulic actuator component
4a first hydraulic fluid chamber
4b second hydraulic fluid chamber
5 total actuator volume
6a first connection point
6b second connection point
7a first line
7b second line
8a first releasable hydraulic closing element
8b second releasable hydraulic closing element
9 other hydraulic components
10 delivery circuit
11 store
12a first further hydraulic closing element
12b second further hydraulic closing element
13 hydraulic release signal input
14 electric release signal input
15 mobile work-performing machine
16 drive power supply
17 controller
18 hydraulic fluid supply
19 displaceable element
20a first hydraulic cross-section
20b second hydraulic cross-section
21a first partial pump chamber
21b second partial pump chamber
22 delta volume
23 hydraulic fluid reservoir
24 actuator movement
25 hydraulic intermediate circuit
26 pump drive motor
27 hydraulic signal line
28 electric signal line

1. An electrohydraulic actuator comprising at least one bidirectionally operable hydraulic pump for conveying hydraulic fluid, said pump having two connection points, which are configured to alternately provide and/or remove hydraulic fluid, and having a hydraulic actuator component having two hydraulic fluid chambers, into which hydraulic fluid can be fed to actuate the hydraulic actuator component, wherein filling of one of the hydraulic fluid chambers with hydraulic fluid simultaneously causes hydraulic fluid to be displaced from the other hydraulic fluid chamber, a first connection point of the electric hydraulic pump is connected by a first line to a first hydraulic fluid chamber of the hydraulic actuator component and a second connection point of the hydraulic pump is connected by a second line to a second hydraulic fluid chamber of the hydraulic actuator component, wherein a first releasable hydraulic closing element is arranged between the first hydraulic fluid chamber and the first line and a second releasable hydraulic closing element is arranged between the second hydraulic fluid chamber and the second line, wherein the releasable hydraulic closing elements prevent an undesired flow of hydraulic fluid out of the hydraulic fluid chambers, wherein the releasable hydraulic closing elements are configured to release, both an electric release signal and a hydraulic release signal applied to the releasable hydraulic closing elements.

2. The electrohydraulic actuator as claimed in claim 1, wherein the releasable hydraulic closing elements are releasable non-return valves.

3. The electrohydraulic actuator as claimed in claim 1, wherein the hydraulic actuator component has a displaceable element via which the hydraulic fluid chambers communicate with one another, and wherein the hydraulic actuator component with the lines and the electric hydraulic pump at least partially form a delivery circuit, so that hydraulic fluid emerging from one hydraulic fluid chamber flows directly into the other hydraulic fluid chamber via the lines and the electric hydraulic pump.

4. The electrohydraulic actuator as claimed in claim 3, wherein the hydraulic fluid chambers of the hydraulic actuator component have hydraulic cross-sections which differ from one another, so that a delta volume occurs as a change in the total volume of the hydraulic fluid chambers when the displaceable element is displaced, wherein the electric hydraulic pump has a two-part pump chamber and a first partial pump chamber connects the lines to form the delivery circuit, and wherein a second partial pump chamber is connected to the line to the hydraulic fluid chambers with the larger hydraulic cross-section and to a hydraulic fluid reservoir with which the delta volume can be compensated.

5. The electrohydraulic actuator as claimed in claim 3, wherein the first line and the second line are each connected to a store for hydraulic fluid, which is set up to compensate for function-related fluctuations in a minimum system pressure in the closed hydraulic system.

6. The electrohydraulic actuator as claimed in claim 5, wherein the store is connected to the first line and the second line via further hydraulic closing elements, wherein these further hydraulic closing elements prevent a transmission of an operating pressure generated by the electric hydraulic pump in one of the two lines to the store.

7. The electrohydraulic actuator as claimed in claim 1, wherein the releasable hydraulic closing elements have a hydraulic release signal input, to which a hydraulic signal line is connected, via which the presence of a hydraulic system pressure of the electrohydraulic actuator is monitored as a hydraulic release signal.

8. The electrohydraulic actuator as claimed in claim 7, wherein the hydraulic release signal input is connected to the store via a hydraulic signal line to monitor the hydraulic system pressure.

9. The electrohydraulic actuator as claimed in claim 1, wherein the releasable hydraulic closing elements have an electric release signal input, to which an electric signal line is connected, via which the presence of a function signal of the electric hydraulic pump and/or a function signal of a drive power supply and/or a controller of the electric hydraulic pump is monitored as an electric release signal.

10. The electrohydraulic actuator as claimed in claim 1, wherein the electric hydraulic pump is arranged to act as a generator to convert mechanical energy of a hydraulic fluid flow from the one connection point into the other connection point into electrical energy.

11. The electrohydraulic actuator as claimed in claim 1, wherein the electrohydraulic actuator is configured to transmit mechanical energy at the hydraulic actuator component through the lines and via the hydraulic fluid to the electric hydraulic pump and to recuperate it into electric energy with the electric hydraulic pump.

12. The electrohydraulic actuator as claimed in claim 1, wherein the hydraulic actuator component is a linear actuator.

13. A mobile work-performing machine comprising at least one electrohydraulic actuator as claimed in claim 1.
